(19) United States
(12) Patent Application Publication
(10) Pub. No.: US 2011/0115383 A1
(43) Pub. Date: May 19, 2011

(54) THERMALLY COMPENSATED END OF LIFE TIMER FOR LED BASED AIRCRAFT LIGHTING

(75) Inventors: William Tyson, III, Urbana, OH (US); Jeffrey M. Singer, Springfield, OH (US); Mark Poling, Springfield, OH (US)

(73) Assignee: HONEYWELL INTERNATIONAL INC., Morristown, NJ (US)

(21) Appl. No.: 12/618,014

(22) Filed: Nov. 13, 2009

(51) Int. Cl. H05B 37/00

(52) U.S. Cl. 315/120; 315/131

(57) ABSTRACT

A thermally compensated End-of-Life (EoL) timer and method. An example method determines if a light emitting diode (LED) is in an ON state. If the LED is determined to be in the ON state, sensing junction temperature or a temperature proximate to the LED that can be correlated back to the LED junction temperature, a fixed frequency clock signal is gated based on the sensed temperature and an accumulative counter value is recorded based on the gated clock signal. An end-of-life signal is generated if the accumulative counter value is at least one of equal to or greater than a predefined threshold value. In one embodiment, the LED is shut off when the end-of-life signal has been generated. In another embodiment, an indication that the LED is at its end of life is provided when the end-of-life signal has been generated.

### BACKGROUND OF THE INVENTION

Aircraft lighting has traditionally been accomplished through the use of filament based light sources such as incandescent or halogen lamps. These light sources offered relatively short life with a catastrophic failure of the filament long before the light output decayed below acceptable levels. Over the past few years the aircraft lighting industry has been migrating to the use of light emitting diodes (LEDs) as the preferred light source. Unlike filament based sources, LED light output tends to degrade slowly over time with the output falling below minimum acceptable standards before the LED fails catastrophically. The LED optical degradation factor is directly related and highly sensitive to the junction temperature of the LEDs (i.e. faster degradation at higher temperatures). LEDs of different colors/materials degrade at different rates.

Some have placed End-of-Life (EoL) Timers in their LED based aircraft lights. The EoL Timers shut down the light after a predetermined number of hours. This helps guarantee to the customer that if the light is ON it still meets the minimum performance standards. This predictive method uses many worst case factors, the most restrictive being a worst case ambient operating temperature. Using these assumptions results in a conservative (i.e. short) life estimate as the majority of lights will shut off before they are truly performing below minimum standards. Thus, there is a need for estimating and measuring degradation over time with consideration for the affects of temperature and LED selection.

### SUMMARY OF THE INVENTION

The present invention provides a thermally compensated End-of-Life (EoL) timer. An example method determines if a light emitting diode (LED) is in an ON state. If the LED is determined to be in the ON state, LED junction temperature is sensed or temperature proximate to the LED is sensed and then is correlated to LED junction temperature, a fixed frequency clock signal is gated based on the sensed temperature and an accumulative counter value is recorded based on the gated clock signal. An end of life signal is generated if the accumulative counter value is at least one of equal to or greater than a predefined threshold value.

In one aspect of the invention, the LED is shut off when the end of life signal has been generated.

In one aspect of the invention, an indication that the LED is at its end of life is provided when the end of life signal has been generated.

Co-owned U.S. Pat. No. 7,391,335 is another LED monitor. It is hereby incorporated by reference.

### BRIEF DESCRIPTION OF THE DRAWINGS

Preferred and alternative embodiments of the present invention are described in detail below with reference to the following drawings:

FIG. 1-1 is a block diagram of an example system formed in accordance with an embodiment of the present invention;

FIG. 1-2 is a block diagram of an example system formed in accordance with an alternate embodiment of the present invention;

FIG. 2 illustrates a flowchart of an example process performed by the components of the system shown in FIG. 1;

FIG. 3 illustrates an example degradation curve for a light emitting diode (LED); and

FIG. 4 illustrates a control curve used by the process shown in FIG. 2 that is based on the degradation curve shown in FIG. 3.

### DETAILED DESCRIPTION OF THE INVENTION

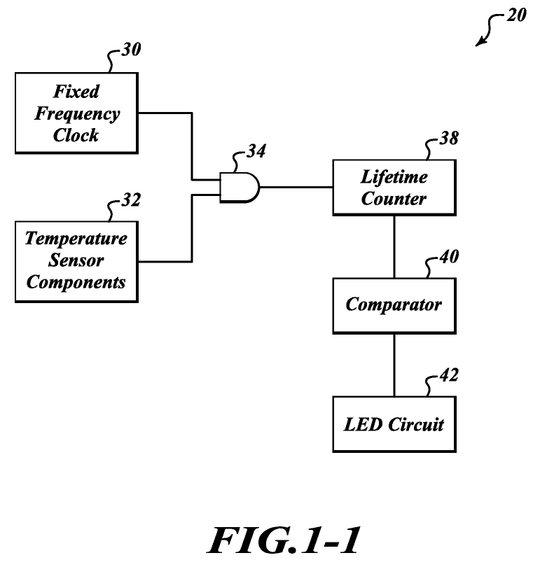

FIG. 1-1 illustrates an example system 20 that includes a thermally compensated End-of-Life timer for light emitting diodes (LEDs). The system 20 is implemented on a dynamic vehicle or system, such as an aircraft. The system 20 includes a fixed frequency clock 30, a temperature sensor component 32, an AND gate 34, a lifetime counter 38, a comparator 40, and an LED circuit 42.

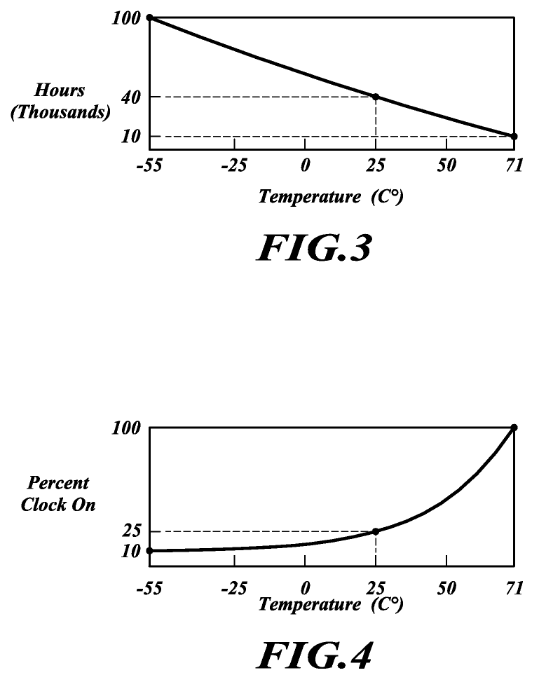

The temperature sensor component 32 senses LED junction temperature directly or a temperature in proximity to a corresponding LED or group of LEDs located in the LED circuit 42. If a proximate temperature is used, the sensed temperature is correlated back to LED junction temperature. Based on the sensed temperature, the temperature sensor component 32 outputs a Pulse-Width Modulated (PWM) signal to the AND gate 34. The PWM signal is based on a predefined control curve similar to the curve shown in FIG. 4. The AND gate 34 gates a clock signal produced by the fixed frequency clock 30 that is sent to the lifetime counter 38. The lifetime counter 38 records the amount of time that the frequency clock signal is received. The comparator 40 periodically compares the value stored in the lifetime counter 38 to a previously defined LED end-of-life value. If the comparator 40 determines that the value located within the lifetime counter 38 is equal to or greater than the previously defined end-of-life value, the comparator 40 sends an end-of-life signal to the LED circuit 42. The LED circuit 42 will disable the associated LEDs or produce some indication that the end of life for the LEDs has occurred when the LED circuit 42 receives the end-of-life signal from the comparator 40.

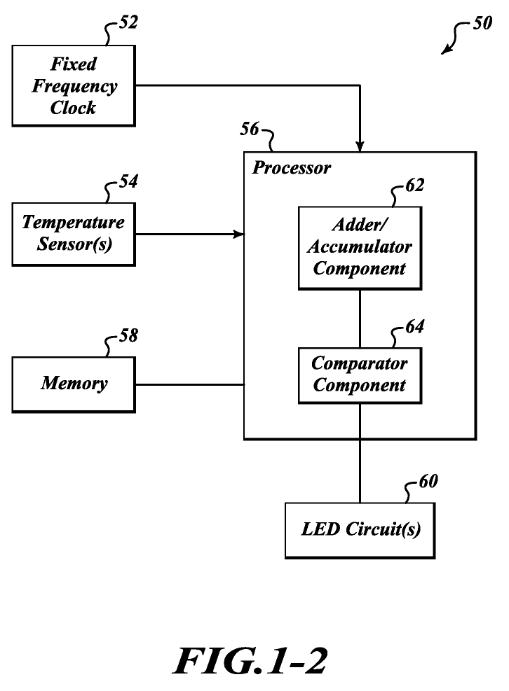

FIG. 1-2 is a system 50 showing an alternate embodiment. The system 50 is preferably implemented in software, but could be implemented in hardware or a combination of hardware and software. The system 50 includes a fixed frequency clock 52, a temperature sensor(s) 54, a processor 56, associated memory 58, and an LED circuit(s) 42. The processor 56 includes an adder/accumulator component 62 and a comparator component 64. When the power is applied to the LED circuit(s) 42, the processor 56 receives the temperature value from the temperature sensor(s) 54 and calculates or retrieves from a look-up table stored in the memory 58 a scaled time value. Based on the clock signal 52 this scaled time value is periodically added to the lifetime count (accumulated ON time) for the LED circuit(s) 42. The comparator component 64 then executes a comparison such as that performed by the comparator 40 described above.

For example, if the sensed temperature is above normal, the adder/accumulator component 62 retrieves the value 2 from the look-up table. This value is then applied to the clock signal. So, if under normal temperature conditions 1 hour of clock is recorded and added to the lifetime count, 2 hours is added to the lifetime counter under this high temperature condition.

FIG. 2 illustrates a flowchart of an example process 80 performed by the system 20 shown in FIG. 1. First, at a decision block 84 the system 20 is enabled once it is determined that the LED(s) is in an ON state, see decision block 84. The state may be determined by any number of methods. For example, the EoL circuit (the lifetime counter 38) is powered by the same power source as the LED circuit or a sensor senses when voltage is applied to the LED circuit 42. Next, at a block 86, a temperature sensor located within the temperature sensor component 32 (or on a circuit board proximate to the associated LED(s)) senses the junction temperature or a proximate temperature that is corrected back to junction temperature. Next, at a block 88, a gate clock signal is generated based on the sensed temperature. In one embodiment, the gate clock signal is generated by a microprocessor located within the temperature sensor component 32 based on a previously defined control curve, such as that shown in FIG. 4. The control curve defines the percentage of time at which the lifetime counter 38 should be recording ON time for the LED(s). For example, if the sensed temperature is 71° C. then the temperature sensor component 32 gates the clock signal through the AND gate 34 100% (i.e. 100% duty cycle) of the time. Thus, forcing the lifetime counter 38 to record the total amount of time that the LED(s) is on.

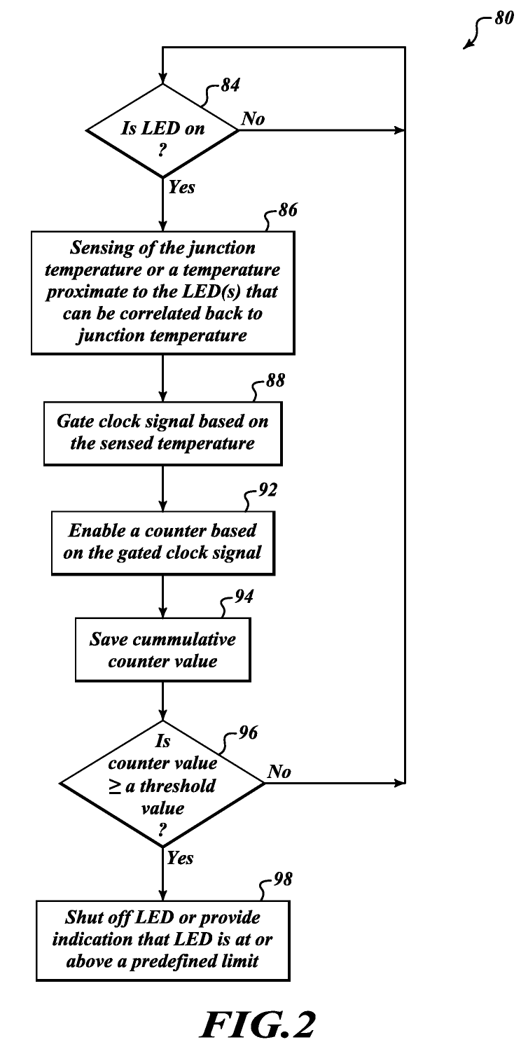

Then at a block 92, the generated gate clock signal is applied to the AND gate 34, thus enabling the clock signal generated by the fixed frequency clock 30 to be applied to the lifetime counter 38. At a block 94, the lifetime counter 38 saves a cumulative counter value based on the clock signal that is received from the AND gate 34. Next at a decision block 96, the comparator 40 compares the cumulative counter value to a predefined threshold value. The predefined threshold value is typically based on a degradation curve, such as that shown in FIG. 3 which is dependent on LED type. Typically one would select the number of operational hours associated with the highest operating temperature on the degradation curve and correlate this temperature to 100% duty cycle of the gating signal. In this case the highest operational temperature on the degradation curve is 71° C. thus correlating to approximately 10,000 operational hours. Therefore, when the cumulative counter value is equal to or greater than 10,000 operational hours an end-of-life signal is sent to the LED circuit 42. When the end-of-life signal is received, the LED circuit 42 will shut off the LED(s) or provide an indication that the LED(s) is at or above a predefined end-of-life limit, see block 98. If the cumulative counter value is not greater than the predefined threshold value the process 80 returns to the beginning of the process.

Other predefined threshold values may be selected from the degradation curve. For example, one may select 40,000 operational hours that correlates to 25° C. if the LED(s) is going to be used in an environment that typically would not see temperatures greater than 25° C. Thus, by selecting a higher threshold value, the determination of end of life based on this process can be extended to an even greater extent.

While preferred and alternate embodiments of the invention have been illustrated and described, as noted above, many changes can be made without departing from the spirit and scope of the invention. For example, the present invention could be performed by discrete components (hardware), software algorithms executed by a microprocessor, a microcontroller or programmable logic, or a combination of hardware and software. Accordingly, the scope of the invention is not limited by the disclosure of the embodiments. Instead, the invention should be determined entirely by reference to the claims that follow.

1. A method comprising:
determining if one or more light emitting diodes (LEDs) is in an ON state;
if the one or more LEDs are determined to be in the ON state,
sensing at least one of an LED junction temperature or a temperature proximate to the one or more LEDs,
at least one of gating a fixed frequency clock signal based on the sensed temperature or computing a scaled time value based on the sensed temperature, and
at least one of recording an accumulative counter value based on the gated fixed frequency clock signal or periodically adding the scaled time value to the accumulative counter value; and
generating an end-of-life signal if the accumulative counter value is at least one of equal to or greater than a predefined threshold value.

2. The method of claim 1, further comprising after sensing correlating the sensed temperature back to a junction temperature if the sensed temperature was a proximate temperature,
wherein gating a fixed frequency clock signal and computing a scaled time value are based on the junction temperature.

3. The method of claim 1, further comprising shutting off the one or more LEDs when the end-of-life signal has been generated.

4. The method of claim 1, further comprising providing an indication that the one or more LEDs are at their end of life when the end-of-life signal has been generated.

5. The method of claim 1, wherein the predefined threshold value is based on a previously defined degradation curve associated with the LED type being monitored.

6. The method of claim 1, wherein enabling of the fixed frequency clock signal is based on a previously defined control curve associated with the LED type being monitored.

7. The method of claim 1, wherein the scaled time value is retrieved from a look-up table.

8. The method of claim 1, wherein the accumulative counter is stored in a non-volatile memory so the count value can be maintained during power off conditions.

9. A device comprising:
one or more LEDs;
a clock configured to generate a fixed frequency clock signal;
a temperature sensor component configured to
sense at least one of a direct junction temperature or a temperature proximate to the one or more LEDs, and
perform at least one of generate a clock enable signal based on the sensed temperature or compute a scaled time value based on the sensed temperature;
a lifetime counter configured to record an accumulative counter value based on one of the fixed frequency clock signal gated by the clock enable signal or periodically adding the computed scaled time value to the accumulative counter; and
a component configured to generate an end-of-life signal if the accumulative counter value is at least one of equal to or greater than a predefined threshold value.

10. The device of claim 9, wherein the temperature sensor component is further configured to correlate the sensed temperature back to a junction temperature, if the sensed temperature was a proximate temperature, and wherein clock enable signal generation and scaled time value computation are based on the junction temperature.

11. The device of claim 9, further comprising a circuit component configured to shut off the one or more LEDs when the end-of-life signal has been generated.

12. The device of claim 9, further comprising a circuit component configured to provide an indication that the one or more LEDs is at its end of life when the end-of-life signal has been generated.

13. The device of claim 9, wherein the predefined threshold value is based on a previously defined degradation curve associated with the type of the one or more LEDs.

14. The device of claim 9, wherein the temperature sensor component generates the clock enable signal based on a previously defined control curve associated with the type of the one or more LEDs.

15. The device of claim 9, wherein the one or more LEDs are part of an aircraft lighting system.

16. The device of claim 9, further comprising a memory configured to store a look-up table comprising a plurality of scaling values.

17. The device of claim 9, further comprising a memory configured to store a look-up table comprising a plurality of scaled time values based on a previously defined control curve associated with the type of the one or more LEDs.

18. The device of claim 9, further comprising a non-volatile memory to store the accumulated count value during power off conditions.

19. A system comprising:
a means for determining if one or more light emitting diodes (LEDs) is in an ON state;
if the one or more LEDs is determined to be in the ON state, a means for
sensing at least one of an LED junction temperature or temperature proximate to the LED,
correlating the sensed temperature back to a junction temperature, if the sensed temperature was a proximate temperature,
performing at least one of generating a clock enable signal based on the junction temperature or computing a scaled time value based on the junction temperature, and
performing at least one of recording accumulative counter value based on one of the gated fixed frequency clock signal or periodically adding the scaled time value; and
a means for generating an end-of-life signal if the accumulative counter value is at least one of equal to or greater than a predefined threshold value.

20. The system of claim 19, further comprising a means for storing a look-up table comprising a plurality of scaled time values.
